(19) United States
(12) Patent Application Publication
(10) Pub. No.: US 2017/0167524 A1
(43) Pub. Date: Jun. 15, 2017

(54) Wear Plate Fastener System

(71) Applicant: Ty Fred Elston, Somerville, Western Australia (AU)

(72) Inventor: Ty Fred Elston, Somerville, Western Australia (AU)

(21) Appl. No.: 15/322,327

(22) PCT Filed: Jun. 5, 2015
(86) PCT No.: PCT/AU2015/050311

§ 371 Date: Dec. 27, 2016

(30) Foreign Application Priority Data
Jun. 27, 2014 (AU) 2014203205

(51) Int. Cl. F16B 37/14; E21F 13/06; B65G 11/16; B02C 23/02; F16B 5/02

(52) U.S. Cl. CPC F16B 37/14; B02C 23/02; F16B 5/02; B65G 11/166; E21F 13/061; B02C 2210/02

(57) ABSTRACT

The present invention provides a wear element assembly comprising: (i) a wear element comprising an aperture adapted to receive a fastener, the aperture having a tapered upper region, (ii) a fastener comprising a head region, and a threaded region distal to head region, the head region of the fastener being tapered so as to frictionally engage with the tapered upper region of the aperture, wherein, in use, the threaded region of the fastener is inserted into the aperture and an underlying substrate to locate the wear element on the substrate, and a nut is wound onto the threaded region to secure the wear element to the substrate.

### FIELD OF THE INVENTION

The present invention relates to wear plates of the type used as a sacrificial lining or surface on heavy equipment, and particularly (although not exclusively) in the field of mining and quarrying.

### BACKGROUND TO THE INVENTION

Mining and quarry operations requires thousands of tons of abrasive and heavy rock material to pass through chutes on the way to processing crushers. The impact and wear of the rock material results in extensive damage to the chute walls in a short time. While such chutes ban be fabricated with very thick walls, when the wear becomes excessive the operation of the processor must be halted while the expensive, time consuming and arduous repair or replacement efforts are undertaken.

Various attempts have been made to protect rock-contacting surfaces of chutes and other items of mining equipment in an effort to avoid the need to replace an entire part due to the inevitable damage. For instance, the prior art provides wear elements that can be secured to the surface of mining equipment to protect that surface. However, many of these elements are welded or bolted on to the surface of the equipment and can be difficult to replace once worn through. In wear elements which have bases and attachable wear plates, when the abrasive wear plate is worn, the engagement means securing the base to the surface is often also damaged, which requires that the entire base be ground or cut off and replaced.

A further problem of the prior art is that where the engagement means is a bolt, a nut must typically be used on the reverse side of the wear plate to prevent loosening the bolt. This requires the wear element installer to have clear access to both sides of the wear plate such that rotation of the bolt can be prevented while the nut is tightened. In some circumstances, it is difficult to access both the front (lining) side of the wear plate and also the rear side. In any event, the need to access both surfaces complicates installation of a wear plate.

Another problem is that some means for engaging a wear element do not allow for the complete wearing of the element. Accordingly the wear material of the element is not completely sacrificed before the element is replaced, this being economically wasteful.

It is an aspect of the present invention to overcome or alleviate a problem of the prior art by providing an improved system for attaching a wear element to heavy equipment. It is a further aspect to provide an alternative to prior art building systems for attaching a wear element to heavy equipment.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect the present invention provides a wear element assembly comprising:
(i) a wear element comprising an aperture adapted to receive a fastener, the aperture having a tapered upper region,
(ii) a fastener comprising a head region, and a threaded region distal to head region, the head region of the fastener being tapered so as to frictionally engage with the tapered upper region of the aperture, wherein, in use, the threaded region of the fastener is inserted into the aperture and an underlying substrate to locate the wear element on the substrate, and a nut is wound onto the threaded region to secure the wear element to the substrate.

In one embodiment, the head region of the fastener is fabricated from a material the same or similar to that of the wear element, or is fabricated from a material that wears at a similar rate to that of the wear element.

In one embodiment, the head region of the fastener is fabricated from a material that is harder than the material of the threaded region.

In one embodiment, the fastener is of composite construction.

In one embodiment, the tapered upper region of the aperture is not of round cross-section.

In one embodiment, the tapered upper region of the aperture has an internal corner in cross-section.

In one embodiment, the tapered upper region of the aperture is generally triangular, square, rectangular, pentagonal, hexagonal, or octagonal in cross-section.

In one embodiment, the tapered upper region of the aperture is generally square or rectangular in cross-section, two opposing sides of the square or rectangular are tapered, and the remaining opposing sides being non-tapered.

In one embodiment, the head region of the fastener is configured such that upper surface of the head region is substantially flush with the surrounding upper surface of the wear element.

In one embodiment, the head region of the fastener is configured such that the head region extends superior to the surrounding upper surface of the wear element.

In one embodiment, the head region of the fastener is configured to block or divert rock travelling over the upper surface of the wear element.

In one embodiment, the wear element comprises two or more apertures.

In one embodiment, the fastener comprises two or more threaded regions.

In one embodiment, faster is configured such that the two or more threaded regions are insertable into the two more apertures.

In one embodiment, the head region may have a thickness equal to or greater than the thickness of the wear element such that the wear element can be substantially or completely worn before the fastener head region is substantially or completely worn.

In a second aspect the present invention provides a fastener configured to secure a wear element to a substrate, the fastener comprising a head region and a threaded region distal to head region, the head region of the fastener being tapered.

In one embodiment, the head region of the fastener is fabricated from a material the same or similar to that of the wear element.

In one embodiment, the head region of the fastener wears at a similar rate to that of the wear element.

In one embodiment, the material of the head region of the fastener is harder than the material of the threaded region.

In one embodiment, the fastener is of composite construction.

In a third aspect the present invention provides a wear element comprising an aperture adapted to receive a fastener, the aperture having a tapered upper region.

In one embodiment, the tapered upper region of the aperture is not of round cross-section.

In one embodiment, the tapered upper region of the aperture has an internal corner in cross-section.

In one embodiment, the tapered upper region of the aperture is generally triangular, square, rectangular, pentagonal, hexagonal, or octagonal in cross-section.

In one embodiment, where the tapered upper region of the aperture is generally square or rectangular in cross-section, two opposing sides of the square or rectangular are tapered, and the remaining opposing sides being non-tapered.

In a fourth aspect the present invention provides a method of securing a wear element to a substrate, the method comprising the step of locating the wear element as described herein about a substrate, and securing the wear element to the substrate using the fastener as described herein.

### BRIEF DESCRIPTION OF THE FIGURES

FIG. 1 shows an exemplary wear plate assembly of the present invention (nut not shown). FIG. 1A is a perspective view. FIG. 1B is a plan view of the assembly of FIGS. 1A and 1B. FIG. 1C is an end view of the assembly of FIG. 1A and FIG. 1B.

FIG. 2A shows in lateral view an exemplary low profile fastener of the present invention. (nut not shown). FIG. 2B shows in lateral view a fastener having a walled head region, and comprising two threaded regions.

FIG. 3A shows in lateral view a wear plate fixed to a substrate structure using a low profile fastener (at right, nut not shown) of the type shown in FIG. 2A. At the left of FIG. 3A there is shown the abutment of the wear plate and substrate, but without a fastener.

FIG. 3B shows in lateral view a walled fastener of the type shown in FIG. 2B fixed to a substrate (nut not shown).

### DETAILED DESCRIPTION OF THE INVENTION

After considering this description it is apparent to one skilled in the art how the invention is implemented in various alternative embodiments and alternative applications. However, although various embodiments of the present invention is described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on Applicant's discovery that a fastener having a tapered head region and a threaded region may be used to secure a wear element (such as a wear plate) to a heavy equipment surface (such as the rock-contacting surface of a chute). The wear element has an aperture that is shaped to fit the taper of the fastener. The threaded region of the fastener is first inserted into the wear element aperture and into an aperture of the heavy equipment surface. A nut is then wound onto the threaded portion and tightened to draw the tapered surface of the aperture and the tapered surface of the fastener together to frictionally engage. Accordingly, in a first aspect the present invention provides a wear element assembly comprising:
(i) a wear element comprising an aperture adapted to receive a fastener, the aperture having a tapered upper region,
(ii) a fastener comprising a head region, and an elongate threaded region distal to head region, the head region of the fastener being tapered so as to frictionally engage with the tapered upper region of the aperture, wherein, in use, the elongate threaded region of the fastener is inserted into the aperture and an underlying substrate to locate the wear element on the substrate, and a nut is wound onto the elongate threaded region to secure the wear element to the substrate.

As used herein, the term “wear element” is intended to mean any structure that is used sacrificially and is therefore replaceable. An exemplary form of a wear element is a wear plate, of the type used in mining to line chutes, hoppers and the like.

According to the invention, the aperture of the wear element has an upper tapered region. As used herein, the term “upper” when used in respect of wear elements is intended to mean in the direction of the sacrificial surface. For example, for a wear plate, the upper surface is that which is intended to contact rock passing over the wear plate. The taper of the tapered region is broad toward the upper surface of the wear element, narrowing toward the lower surface of the wear element. Where the wear element is a wear plate, the lower surface is that which abuts the substrate, the substrate typically being a part of a heavy piece of equipment. The tapered region generally commences at the surface and terminates at a point distal to the lower surface of the wear element. Typically, at the point of termination of the tapered region, the aperture may become generally cylindrical, and dimensioned so as to accommodate the threaded region of the fastener. In some embodiments, the entire aperture is tapered (i.e. from the upper surface to the lower surface) albeit with the narrow region of the taper being dimensioned so as to allow the threaded region of the fastener to pass therethrough.

The threaded region of the fastener is dimensioned so as to extend past the lower surface of the wear element and into the substrate onto which the element is to be secured. The substrate may be a frame member, a plate or any other structure to be protected by the wear element. The substrate typically has an aperture into which the threaded region of the fastener extends, the threaded region being dimensioned so as the terminal region of the threaded region extends through the substrate. It is to this terminal region that a nut is applied and wound thereon. The nut (which may have an underlying washer) acts to (i) prevent the threaded region from pulling back through the substrate and the wear element and (ii) when tightened, to pull the tapered head region of fastener into the tapered region of the wear element aperture. As will be appreciated, when sufficiently tightened the two tapered regions frictionally engage and therefore the wear element is very tightly secured to the underlying substrate.

Provision of a tapered region, and particularly wear the taper extends the entire depth of the apertures provides the further advantage in that the wear element is maintained securely on the substrate even where the wear element is almost completely worn.

Preferably the aperture is of cross-sectional which that not round. Furthermore, the head region of the fastener is not round in some embodiments. Avoidance of a round aperture and/or avoidance of a round fastener head region prevents (or at least limits) rotation of the fastener within the aperture when the bolt is wound onto the fastener threaded region. Advantageously, therefore it becomes unnecessary for the installer to actively prevent rotation of the fastener within the aperture when winding the bolt onto the threaded region. In prior art assemblies both fastener and apertures are round, and the installer typically restrains rotation by gripping the fastener at the upper region of the wear element while winding the nut. This requirement complicates and generally slows the application of the fasteners.

Preferably the aperture has two opposing tapered walls, and two opposing non-tapered walls. Typically the aperture is square or rectangular in this arrangement. Apertures having non-tapered wall(s) provide for greater resistance to rotation of the fastener during winding of the nut to the threaded region. As will be appreciated, the head region of the fastener in such embodiments will has non-tapered wall(s) to abut the non-tapered wall(s) of the aperture.

The very tight nature of the coupling between the fastener and the wear element (and therefore the substrate and the wear element) is of significant advantage in the present applications given the significant forces acting on a wear element subject to constant abrasion and impact of rock during service.

The coupling between the tapered surfaces of the aperture and the fastener head region is improved where the taper angle is not equal. It is preferred that the taper angle of the fastener head region is slightly smaller than the taper angle of the aperture, this allowing a more complete seating of the fastener head region into the wear element aperture. In one embodiment, the taper angle of fastener head region is between about 0.5 degrees to about 5 degrees smaller than the taper angle of the wear plate apertures. More preferably, the angle is about 2 degrees smaller.

Suitable taper angles for the wear element aperture may be about 119 degrees, with the taper of the fastener head region being about 117 degrees. Other taper angles of about 110, 115, 120, 125, 130, 135, 140, 145, 150, 155 or 160 degrees are further contemplated to be useful in some applications.

The head region of the fastener may be fabricated from a material that wears at a similar rate to that of the wear element. Thus, where the upper surface of the fastener head region is exposed to rock or other abrasive material, the head region is sacrificed in a similar way to the surrounding upper surface of the wear element. In that way, the wear surface (being comprised of the upper surface of the wear element and the upper surface of the fastener head region) wears evenly, with the upper surface of the fastener head region being substantially flush with the upper surface of the wear element.

In some embodiments, the head region of the fastener is configured to extend superior to the surrounding upper surface of the wear element. The superior portion of the head region may be generally block shaped, wall shaped, dome shaped, pyramidal, or any other geometry considered useful by the skilled person. In such cases the head region may be fabricated from a material that wears at a similar rate or a lesser rate to that of the wear element. It will be appreciated that where the fastener head region extends above the wear element upper surface, significantly greater forces may be encountered by the greater opportunity for collision with rocks travelling over the wear element.

The use of a head region extending superior to the surrounding upper surface of the wear element allows for the disposition of barriers, walls, channels and other structures on the wear element surface. For example, superior head regions of a plurality of fasteners may form two parallel walls along the longitudinal edges of a chute. The walls may be capable of preventing (or at least limiting) the loss of rock over the edge of the chute. Alternatively, converging walls may be established to channel rock toward the centre of the chute. Given the benefit of the present specification, the skilled person is enabled to define wall dimensions suitable for a given application. In some embodiments, the wall may be at least about 5, 10, 15, 20, 25, 30, 35, 40, 45, 50, 60, 70, 80, 90 or 100 cm high. In terms of wall thickness, this will typically be a function of height (a greater wall height requiring a greater wall thickness). In some embodiment, the wall thickness is at least about 20, 25, 26, 27, 28, 29, 30, 31, 32, 33, 34, 35, 35, 37, 38, 39 or 40 cm.

In such embodiments, the fastener may comprise two or more threaded portions, the threaded portions being spaced similarly to two or more apertures in the wear plate.

The use of multiple threaded regions with fastener head region disposed between the threaded portions provides for significant mechanical support for a wall as described supra. For example, where the fastener comprises two threaded regions, the threaded regions act as posts to support the head region. The threaded regions act to resist any disturbance of the wall in response to any lateral force occasioned by a rock or other object colliding side-on.

It will be understood that a fastener having a single threaded portion may have a head region configured to extend above the surrounding wear element upper surface.

Given the benefit of the present specification a skilled person may conceive of many means of fabricating a fastener of the present invention. In one embodiment, the fastener may be a composite, with the threaded region fabricated separately to the head region. For example, the fastener may be fabricated from an industry standard bolt (such as an 8.8 grade bolt) to which is welded (or otherwise substantially irreversibly fixed) a head region. Thus, the standard bolt provides (i) the threaded region and (ii) a support for the head region.

The head region may be fabricated from any material capable of resisting wear or capable of wearing at a desired rate. For example, where the head region comprises a wall a very hard steel such as high carbon steel (600 grade, for example) may be used. The hardness of the wall significantly limits wear of the wall, and may act to limit the ability of rocks to contact the main wear surface.

It is contemplated that fasteners or unitary construction may be cast, moulded, stamped, forged or otherwise formed from a single material.

In one embodiment, the fastener head region may have a depth equal to, or preferably greater, than the thickness of the wear element. By this arrangement, the wear element can be substantially or completely worn before the fastener head region is substantially or completely worn. This embodiment provides that all, or substantially all, of the wear element is worn down without the wear element being dislodged from the substrate. In prior art wear plate assemblies, at least part of the bolt fastening the plate to the substrate is disposed within the sacrificial material of the wear plate. Accordingly, where the sacrificial material is worn too far the ability of the bolt to secure the plate is compromised and the plate may dislodge from the substrate. Accordingly, it is standard practice in the art to avoid that situation and to replace a wear plate when some sacrificial material is remaining. The present invention avoids the waste associated with that approach of the prior art.

In a second aspect, the present invention provides a fastener configured to secure a wear element to a substrate, the fastener comprising a head region and a threaded region distal to head region, the head region of the fastener being tapered. For the sake of clarity and brevity, various features of the fastener discussed supra in the context of the assembly will not be repeated here. It is understood that all such features are incorporated herein by reference.

In a third aspect, the present invention provides a wear element comprising an aperture adapted to receive a fastener, the aperture having a tapered upper region. For the sake of clarity and brevity, various features of the wear element discussed supra in the context of the assembly will not be repeated here. It is understood that all such features are incorporated herein by reference.

Any wear element, or part of a wear element, or fastener, or part of a fastener required to have a particular hardness, a material having a Brinell hardness of at least about 100, 150, 200, 250, or 300 HB may be used. Preferably, the material has a Brinell hardness of at least about 300 HB.

In a fourth aspect, the present invention provides a method of securing a wear element to a substrate, the method comprising the step of locating the wear element as described herein about a substrate, and securing the wear element to the substrate using the fastener as described herein. Typically, the method comprises the further step of winding a nut onto the threaded region of the fastener and tightening the fastener. This may be achieved with an impact wrench, or other suitable hand tool.

Bolt Description: the bolt design is for inter locking and holding in of wear plates for the mining and earthmoving industry. This bolt can be installed and tightened by only having to tighten the nut up, the bolt is tapered on an angle that allows it to grip on the bottom of the hole walls in the plate. This allows the plate to wear down completely while holding the plate in position.

Wear Block: the wear block works on the same principle as the bolt but also uses hardened plate to give a rock ledge for increasing wear capabilities.

The present invention will now be further described by way of the following non-limiting preferred embodiments.

### Preferred Embodiment of the Invention

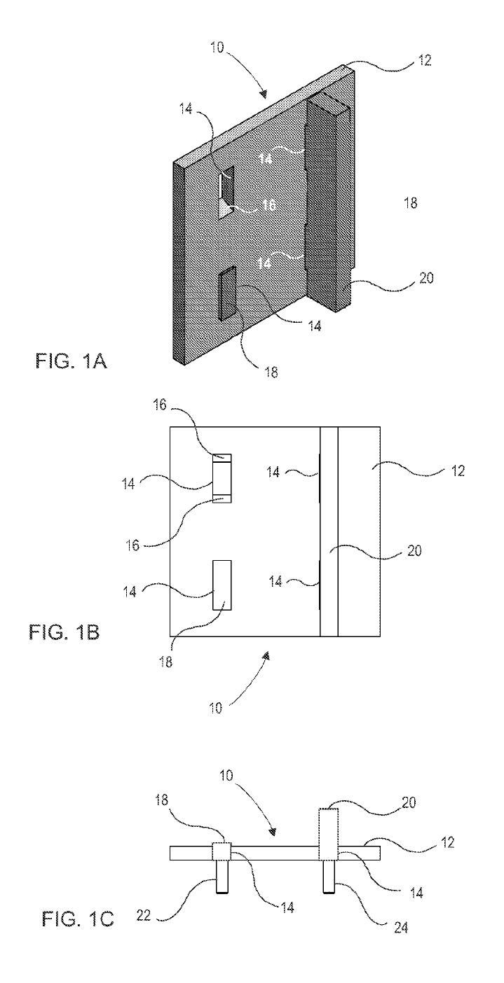

Turning to the Figures, in FIG. 1 there is generally shown a wear plate assembly 10 comprising a wear plate 12, having a total of four apertures 14. Each aperture 14 is generally rectangular and has opposing tapered walls 16, the angle of taper being 119 degrees. The remaining opposing walls of the aperture (not marked) are not tapered.

Two types of fasteners are shown. The first type of fastener has a head region 18 of low profile, while the second type has a walled head region 20 extending above the upper surface of the wear plate 12. The first type of fastener has a single threaded region 22, while the second type is wider, and has two threaded regions 24.

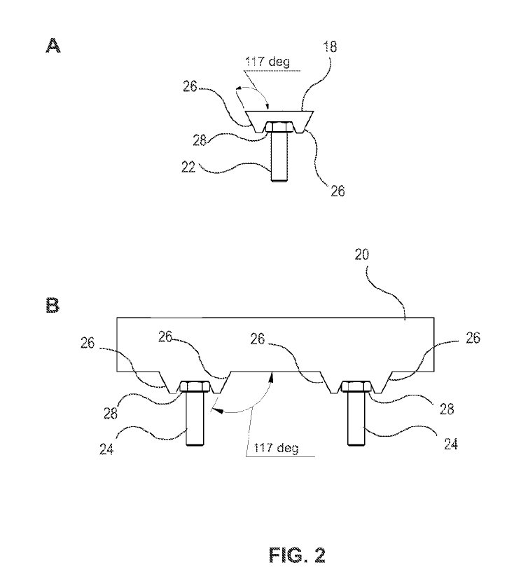

FIG. 2 shows more clearly the two types of fastener with FIG. 2A showing the low profile type having a shallow head region 18, and tapered sides 26. The tapered sides 26 of the fastener head region have a taper angle of 117 degrees, allowing insertion into an aperture 14. FIG. 2b shows a fastener having a walled head region 20, with tapered walls 26 (also at an angle of 117 degrees) and therefore capable of insertion into an aperture 14.

It will be noted that both types of fastener are constructed from an industry standard bolt, the bolthead 28 welded to the head region (18 or 20).

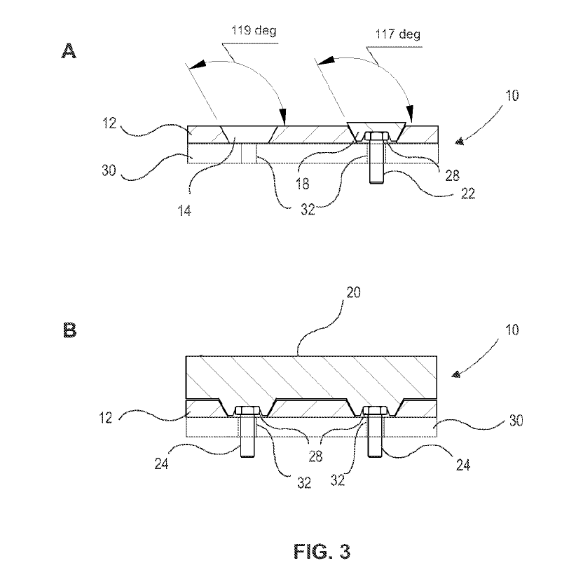

FIG. 3 shows both type of fastener inserted through a wear plate 12 and into a substrate layer 30. The threaded region 22 or 24 inserts through a tapered wear plate aperture 14 and a non-tapered substrate layer aperture 32 such that at least part of the threaded region 22 or 24 is free to receive a nut (not shown).

In both FIGS. 3A and 3B the fastener head region 18 or 20 is fabricated from the same material as the wear plate 12. Turning firstly to FIG. 3A it will be apparent that the wear plate 12 and head region 18 can be worn a substantial amount before the bolt head 28 is exposed. For the embodiment of FIG. 3B the head region 20 can be completely worn before the bolthead 28 is exposed.

It will be further apparent that even in the process of the wear plate 12 and head region 18 or 20 being worn down, the tapered engagement between head region 18 or 20 and aperture 14 ensures the wear plate remains fixed to the substrate 30.

While the present invention is described mainly by reference to the attachment of a wear plate onto a chute, it will be appreciated that this is not intended to limit the ambit of this application.

It should be appreciated that in the above description of exemplary embodiments of the invention, various features of the invention are sometimes grouped together in a single embodiment, figure, or description thereof, for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, components and functionality may be added or deleted from diagrams and operations may be interchanged among functional blocks. Steps may be added or deleted to methods described within the scope of the present invention.

1. A wear element assembly comprising:
(i) a wear element comprising an aperture adapted to receive a fastener, the aperture having a tapered upper region,
(ii) a fastener comprising a head region, and a threaded region distal to head region, the head region of the fastener being tapered so as to frictionally engage with the tapered upper region of the aperture, wherein, in use, the threaded region of the fastener is inserted into the aperture and an underlying substrate to locate the wear element on the substrate, and a nut is wound onto the threaded region to secure the wear element to the substrate.

2. The wear element assembly of claim 1 wherein the head region of the fastener is fabricated from a material the same or similar to that of the wear element.

3. The wear element assembly of claim 1 wherein the head region of the fastener is fabricated from a material that wears at a similar rate to that of the wear element.

4. The wear element assembly of claim 1 wherein the head region of the fastener is fabricated from a material that is harder than the material of the threaded region.

5. The wear element assembly of claim 1 wherein the fastener is of composite construction.

6. The assembly of claim 1 wherein the tapered upper region of the aperture is not of round cross-section.

7. The assembly of claim 1 wherein the tapered upper region of the aperture has an internal corner in cross-section.

8. The assembly of claim 1 wherein the tapered upper region of the aperture is generally triangular, square, rectangular, pentagonal, hexagonal, or octagonal in cross-section.

9. (canceled)

10. (canceled)

11. (canceled)

12. (canceled)

13. The assembly of claim 1 wherein the wear element comprises two or more apertures and the fastener comprises two or more threaded regions, and wherein the faster is configured such that the two or more threaded regions are insertable into the two more apertures.

14. (canceled)

15. (canceled)

16. The assembly of claim 1 wherein the head region may have a thickness equal to or greater than the thickness of the wear element such that the wear element can be substantially or completely worn before the fastener head region is substantially or completely worn.

17. A fastener configured to secure a wear element to a substrate, the fastener comprising a head region and a threaded region distal to head region, the head region of the fastener being tapered.

18. The fastener of claim 17 wherein the head region of the fastener is fabricated from a material the same or similar to that of the wear element.

19. The fastener of claim 17 wherein the head region of the fastener wears at a similar rate to that of the wear element.

20. The fastener of claim 17 wherein the material of the head region of the fastener is harder than the material of the threaded region.

21. The fastener of claim 17 wherein the fastener is of composite construction.

22. A wear element comprising an aperture adapted to receive a fastener, the aperture having a tapered upper region.

23. The wear element of claim 22 wherein the tapered upper region of the aperture is not of round cross-section.

24. The wear element of claim 22 wherein the tapered upper region of the aperture has an internal corner in cross-section.

25. The wear element of claim 24 wherein the tapered upper region of the aperture is generally triangular, square, rectangular, pentagonal, hexagonal, or octagonal in cross-section.

26. (canceled)

27. (canceled)
